(19) United States
(12) Patent Application Publication
(10) Pub. No.: US 2009/0060329 A1
(43) Pub. Date: Mar. 5, 2009

(54) Image Data Analyzing Device, Image Data Analyzing Method, and Computer Program

(75) Inventors: Ayahiro NAKAJIMA, Matsumoto-shi (JP); Seiji AISO, Shiojiri-shi (JP); Kenji MATSUZAKA, Shiojiri-shi (JP); Takashige TANAKA, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/201,497

(22) Filed: Aug. 29, 2008

(30) Foreign Application Priority Data
Sep. 4, 2007 (JP) 2007-228605

(51) Int. Cl. G06K 9/03

(52) U.S. Cl. 382/170

(57) ABSTRACT

An image data analyzing device that reads and analyzes image data includes a number-of-blurred-pixels detecting unit that detects a number of blurred pixels, which is a number of pixels indicating blur width of a contour in an image represented by the image data, a number-of-image-pixels acquiring unit that acquires a number of image pixels, which is a number of pixels related to a size of the image represented by the image data, and an upper-limit-output-size determining unit that determines, on a basis of the number of blurred pixels and the number of image pixels of the image data, an allowable upper limit output size of an image outputted by using the image data.

### BACKGROUND

1. Technical Field

The present invention relates to a technique for outputting, in an appropriate size, an image stored as digital data.

2. Related Art

In these days, images can be readily treated as digital data. For example, when a digital camera is used, photographs as high in quality as silver halide photographs can be easily taken. When photographed digital data is supplied to a printing apparatus such as an ink-jet printer, high-quality printed images can also be easily obtained.

Since images are digital data, it is also easy to changes sizes of the images when the images are outputted. For example, when the images are printed by the printing apparatus, the images are enlarged or reduced according to a sheet size. Alternatively, when the images are displayed on a display device or the like, the images can be enlarged or reduced according to a size of a display area.

However, when it is attempted to output the images in an excessively large size, roughness of pixels of the digital camera becomes conspicuous because the images are enlarged. As a result, a quality of output images may be deteriorated. Therefore, there is proposed a technique for obtaining the number of pixels of a digital camera used for photographing images and determining, according to the number of pixels, an appropriate output size for preventing roughness of the images from becoming conspicuous (JP-A-2006-217182).

However, even if the proposed technique is adopted, images cannot always be outputted in an appropriate size. In other words, even if images are photographed with the same number of pixels, the images cannot always withstand enlargement to the same size. In some case, an image with a small number of pixels can better withstand enlargement to a large size than an image with a large number of pixels. Therefore, an appropriate output size is unknown unless images are actually outputted.

### SUMMARY

An advantage of some aspects of the invention is to provide a technique for allowing a user to output, in an appropriate output size, images stored as digital data.

According to a first aspect of the invention, there is provided an image data analyzing device that analyzes image data, the image data analyzing device including a number-of-blurred-pixels detecting unit that detects the number of blurred pixels, which is the number of pixels indicating blur width of a contour in an image represented by the image data, a number-of-image-pixels acquiring unit that acquires the number of image pixels, which is the number of pixels related to a size of the image represented by the image data, and an upper-limit-output-size determining unit that determines, on the basis of the number of blurred pixels and the number of image pixels of the image data, an allowable upper limit output size of an image outputted by using the image data.

According to a second aspect of the invention, there is provided an image data analyzing method of analyzing image data, the image data analyzing method including a number-of-blurred-pixels detecting step of detecting the number of blurred pixels, which is the number of pixels indicating blur width of a contour in an image represented by the image data, a number-of-image-pixels acquiring step of acquiring the number of image pixels, which is the number of pixels related to a size of the image represented by the image data, and an upper-limit-output-size determining step of determining, on the basis of the number of blurred pixels and the number of image pixels of the image data, an allowable upper limit output size of an image outputted by using the image data.

In the image data analyzing device and the image data analyzing method according to the first and second aspects of the invention, when image data is read, the number of image pixels, which is the number of pixels related to a size of an image, is acquired. The number of image pixels may be any kind of number of pixels as long as the number of pixels is related to the size of the image. For example, the number of image pixels may be a total number of pixels of the image, may be the number of vertical pixels of the image or the number of horizontal pixels of the image, or may be the number of pixels on a diagonal. The number of image pixels may be acquired from the image data by analyzing the image data or may be acquired separately from the image data. In the image data analyzing device and the image data analyzing method according to the first and second aspects of the invention, the number of pixels representing blur width of a contour in an image (the number of blurred pixels) is acquired by analyzing the image data. If the number of image pixels related to the size of the image and the number of blurred pixels are known, it is possible to learn in which size the blur width is outputted when the image data is outputted in a certain image size. Therefore, it is possible to determine an upper limit output size that fits in allowable blur width.

The number of blurred pixels reflects a state of focusing and presence or absence of hand shake at the time when the image is photographed. Therefore, the upper limit output size determined on the basis of the number of image pixels and the number of blurred pixels of the image data represents a largest image size in which the image can be outputted at allowable levels of defocusing and hand shake. Consequently, if the image is outputted within a range of the upper limit output size acquired on the basis of the number of image pixels and the number of blurred pixels of the image data, it is possible to always output the image with a satisfactory image quality without making defocusing and hand shake conspicuous.

In the image data analyzing device according to the first aspect of the invention, when an image size in which the image is about to be outputted is set, image data having an upper limit output size larger than the set image size may be selected by determining an upper limit output size for each of the plural image data stored in advance.

When the upper limit output size of the image data is larger than the set image size, this means that, even if the image is outputted in the set size, it is possible to output the image without making defocusing and hand shake conspicuous. Therefore, if image data having an upper limit output size larger than the set image size is selected out of the plural image data, even if a large number of image data are stored, it is possible to easily select image data that can be outputted with a satisfactory image quality.

When the upper limit output size is determined in the image data analyzing device according to the first aspect of the invention, the upper limit output size may be determined as described below. Blur width at the time when the image is outputted in a certain image size is actually calculated on the basis of the number of image pixels and the number of blurred pixels of the image data. The upper limit output size may be determined by comparing the calculated blur width and a predetermined blur allowable width.

If the actual blur width is calculated on the basis of the number of image pixels and the number of blurred pixels and then the obtained blur width and the predetermined blur allowable width are compared in this way, it is possible to determine the upper limit output size. In such a method, even when blur allowable width is different for each of image sizes, it is possible to easily determine an appropriate upper limit output size. Alternatively, when blur allowable width is determined according to a situation in which a user enjoys an image such as a distance to the image in enjoying the image, it is also possible to easily determine an appropriate upper limit output size. For example, even if image data is the same, degrees of conspicuousness of defocusing and hand shake are different when the user enjoys an output image at a distance of 30 cm and when the user enjoys the output image at a distance of 1 m. Upper limit image sizes in which the image can be outputted without making defocusing and hand shake conspicuous are also different. However, even in such a case, since an appropriate upper limit output size can be determined, it is possible to always output high-quality images.

According to a third aspect of the invention, there is provided an image data analyzing device that analyzes image data, the image data analyzing device including a number-of-blurred-pixels detecting unit that detects the number of blurred pixels, which is the number of pixels indicating blur width of a contour in an image represented by the image data, a number-of-image-pixels acquiring unit that acquires the number of image pixels, which is the number of pixels related to a size of the image represented by the image data, an image-size setting unit that sets an image size, which is a size of an image about to be outputted by using the image data, and an output-possibility judging unit that judges whether the image data can be outputted in the image size by comparing a ratio of the number of blurred pixels to the number of image pixels of the image data and a reference value stored in advance in association with the image size.

According to a fourth aspect of the invention, there is provided an image data analyzing method of analyzing image data, the image data analyzing method including a number-of-blurred-pixels detecting step of detecting the number of blurred pixels, which is the number of pixels indicating blur width of a contour in an image represented by the image data, a number-of-image-pixels acquiring step of acquiring the number of image pixels, which is the number of pixels related to a size of the image represented by the image data, an image-size setting step of setting an image size, which is a size of an image about to be outputted by using the image data, and an output-possibility judging step of judging whether the image data can be outputted in the image size by comparing a ratio of the number of blurred pixels to the number of image pixels of the image data and a reference value stored in advance in association with the image size.

In the image data analyzing device and the image data analyzing method according to the third and fourth aspects of the invention, when image data is read, the number of pixels related to a size of an image (the number of image pixels) is acquired and the number of blurred pixels representing a degree of a blur of a contour in the image is detected by analyzing the image data. It is judged whether the image can be outputted in the image size by comparing a reference value stored in advance for each size of an image about to be outputted (image size) and a ratio of the number of blurred pixels to the number of image pixels.

As described above, if the number of image pixels and the number of blurred pixels of the image data are known, it is possible to determine blur width at the time when the image data is outputted in a certain image size. This relation between the number of image pixels and the number of blurred pixels and the blur width can be more simply defined by using an index obtained by dividing the number of blurred pixels by the number of image pixels. As a value of the index obtained by dividing the number of blurred pixels by the number of image pixels is larger, blur width at the time when the image data is outputted in a certain image size increases. If the index obtained by dividing the number of blurred pixels by the number of image pixels is substantially the same value, the blur width at the time when the image data is outputted in a certain image size is also substantially the same. On the other hand, blur width allowable at the time when an image is outputted in a certain image size is generally decided empirically. More strictly, allowable blur width is different for each of image sizes. However, in any case, once an image size to be outputted is determined, the allowable blur width is determined. As described above, blur width in a certain image size depends on the index obtained by dividing the number of blurred pixels by the number of image pixels. Therefore, a reference value of an index that just fits the blur width to the allowable blur width can be set for each of image sizes. If the reference value set for each of image sizes and the index obtained from the image data (a value obtained by dividing the number of blurred pixels by the number of image pixels) are compared, it is possible to easily judge whether a blur is conspicuous when the image data is outputted in a certain image size. Therefore, it is possible to easily select image data that can be outputted without making a blur conscious.

In the invention, it is also possible to realize the image data analyzing method according to the second or the fourth aspect by causing a computer to read a computer program included on a computer-readable medium, for realizing the image data analyzing method and execute a predetermined function. Therefore, the invention also includes an aspect as a computer program described below.

A computer program corresponding to the image data analyzing method according to the second aspect is a computer program for analyzing image data using a computer, the computer program causing the computer to realize a number-of-blurred-pixels detecting function of detecting the number of blurred pixels, which is the number of pixels indicating blur width of a contour in an image represented by the read image data, a number-of-image-pixels acquiring function of acquiring the number of image pixels, which is the number of pixels related to a size of the image represented by the image data, and an upper-limit-output-size determining function of determining, on the basis of the number of blurred pixels and the number of image pixels of the image data, an allowable upper limit output size of an image outputted by using the image data.

A computer program corresponding to the image data analyzing method according to the fourth aspect is a computer program for and analyzing image data using a computer, the computer program causing the computer to realize a number-of-blurred-pixels detecting function of detecting the number of blurred pixels, which is the number of pixels indicating blur width of a contour in an image represented by the image data, a number-of-image-pixels acquiring function of acquiring the number of image pixels, which is the number of pixels related to a size of the image represented by the image data, an image-size setting function of setting an image size, which is a size of an image about to be outputted by using the image data, and an output-possibility judging function of judging whether the image data can be outputted in the image size by comparing a ratio of the number of blurred pixels to the number of image pixels of the image data and a reference value stored in advance in association with the image size.

If the computer is caused to read these programs and realize the respective functions described above, it is possible to output an image in an appropriate size.

### BRIEF DESCRIPTION OF THE DRAWINGS

The invention will be described with reference to the accompanying drawings, wherein like numbers reference like elements.

FIG. 1 is a diagram for explaining a printing apparatus mounted with an image data analyzing device according to an embodiment of the invention.

FIG. 2 is a flowchart showing a flow of image data analysis processing according to the embodiment.

FIGS. 3A to 3E are diagrams for explaining a state in which edges in an image is detected by using Sobel filters.

FIG. 4 is a diagram for explaining image data for one block stored in a JPEG format.

FIGS. 5A and 5B are diagrams for explaining a method of calculating, from blur width on image data, blur width of an image actually printed.

FIG. 6 is a diagram for explaining a method of determining a printable size from a relation between blur width and a visibility limit on a print sheet.

FIGS. 7A and 7B are diagrams for explaining, using formulas, a method of determining a printable size from the relation between blur width and a visibility limit on a print sheet.

FIG. 8 is a diagram for explaining a state in which recommended sheet sizes are displayed on a monitor screen.

FIG. 9 is a flowchart showing a flow of image data selection processing according to the embodiment.

FIG. 10 is a diagram for explaining an example of a state in which an image selected by the image data selection processing is displayed on the monitor screen.

FIG. 11 is a diagram for explaining a state in which a user selects a portion to be printed of an image in a first modification of the embodiment.

FIG. 12 is a diagram for conceptually explaining a state in which a visibility limit changes according to a distance for enjoying an image.

FIG. 13 is a diagram for explaining an example of a state in which recommended sheet sizes are displayed on a monitor screen in a second modification of the embodiment.

### DESCRIPTION OF EXEMPLARY EMBODIMENTS

Embodiments of the invention are explained according to order described below to clarify the contents of the invention described above.

A. Apparatus configuration

B. Image data analysis processing

C. Image data selection processing

D. Modification
D-1. First modification
D-2. Second modification

### A. Apparatus Configuration

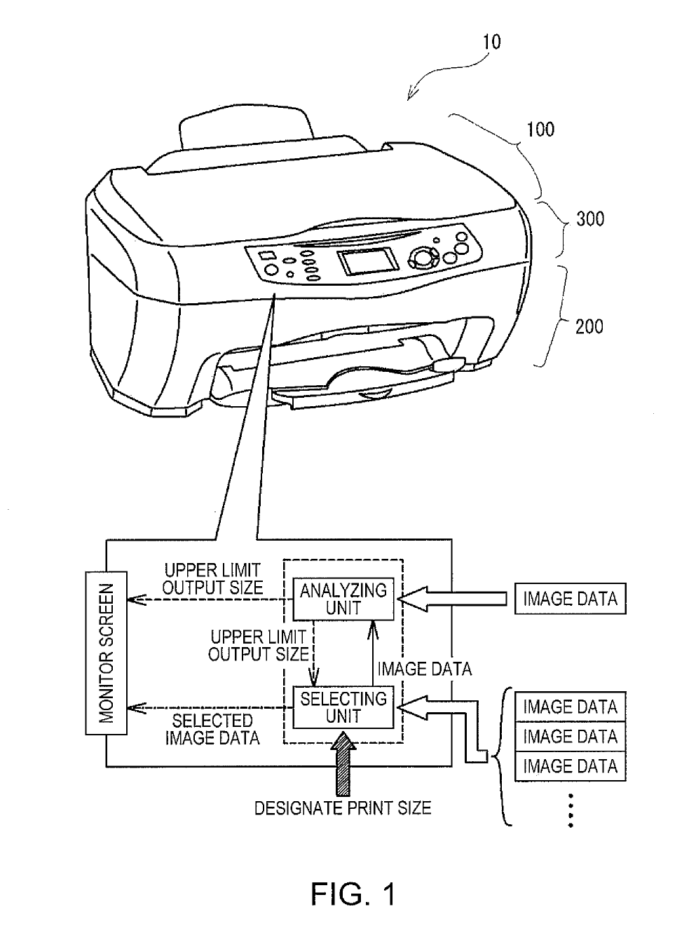

FIG. 1 is a perspective view showing a printing apparatus 10 mounted with an image data analyzing device according to this embodiment. As shown in the figure, the printing apparatus 10 includes a scanner unit 100, a printer unit 200, and a control unit 300 that controls operations of the scanner unit 100 and the printer unit 200. The scanner unit 100 has a scanner function of scanning a printed image and generating image data. The printer unit 200 has a printer function of receiving the image data and printing an image on a print medium. If the image scanned by the scanner unit 100 is outputted from the printer unit 200, it is also possible to realize a copy function. In other words, the printing apparatus 10 according to this embodiment is a scanner/printer/copier complex apparatus that alone can realize the scanner function, the printer function, and the copy function.

The control unit 300 is mounted with a CPU, a ROM, a RAM, and the like and can execute various kinds of processing in addition to the control of the scanner unit 100 and the printer unit 200. For example, when a user sets a print size in printing an image, the printing apparatus 10 can print the image after enlarging or reducing the image according to the set print size. In setting a print size, if the user designates an excessively large size, roughness of the image may become conspicuous and deteriorate a quality of a printed image. Therefore, the printing apparatus 10 also has a function of displaying a maximum size in which the image can be outputted with a suitable quality (an upper limit output size) on a monitor screen by analyzing image data. Alternatively, if a print size is set, it is also possible to select, out of plural image data, image data that can be printed in the size while a quality is secured and display the image data on the monitor screen.

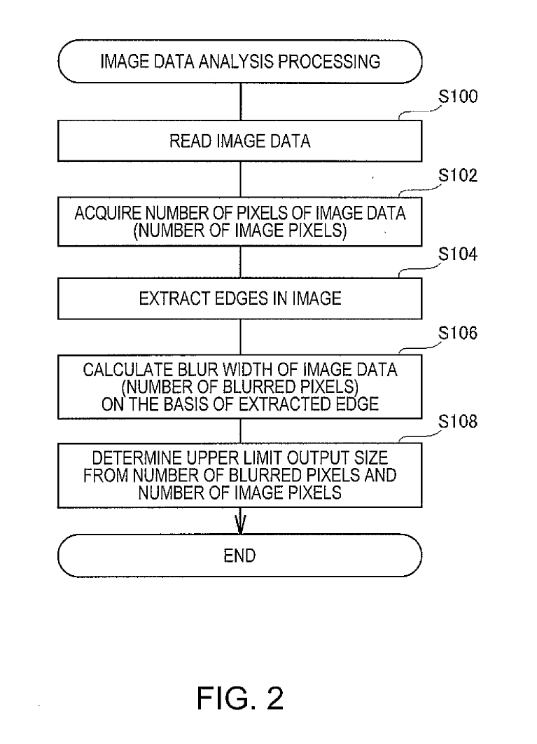

In FIG. 1, a state in which a function of analyzing image data is installed in the control unit 300 of the printing apparatus 10 according to this embodiment is conceptually shown. For example, when image data about to be printed is supplied to an analyzing unit, the analyzing unit analyzes the image data to thereby calculate an upper limit output size and display the upper limit output size on the monitor screen. Alternatively, when a print size is designated to a selecting unit, the selecting unit reads image data from an internal or external memory and analyzes the image data to thereby select image data having an upper limit output size larger than the designated print size and displays the image data on the monitor screen. In FIG. 1, the analyzing unit and the selecting unit are explained as performing respective kinds of processing. However, actually, both of these kinds of processing are executed by the control unit 300. Such processing performed by the control unit 300 is explained in detail below with reference to a flowchart in FIG. 2.

### B. Image Data Analysis Processing

FIG. 2 is a flowchart for explaining a flow of “image data analysis processing” executed by the control unit 300. Such processing is processing executed to inform the user of an appropriate print size after the user selects image data to be printed. As shown in the figure, when the processing is started, the control unit 300 performs processing for reading image data selected by the user (step S100). The image data to be read may be recorded in a computer connected to the printing apparatus 10 or may be recorded in a recording medium such as a memory card inserted in the printing apparatus 10. When the image data is read, subsequently, the control unit 300 performs processing for acquiring the number of pixels related to a size of the image data (the number of image pixels) (step S102). The number of image pixels may be any kind of number of pixels as long as the number of pixels is related to a size of an image. For example, the number of image pixels may be a total number of pixels of the image or may be the number of vertical pixels or the number of horizontal pixels. Usually, the image data has a header section in which a data format such as the number of pixels is recorded. Therefore, it is possible to acquire the number of image pixels by analyzing the header section of the read image data. It goes without saying that image data body may be analyzed rather than the header section. In the following explanation of this embodiment, it is assumed that the number of horizontal pixels of an image is acquired as the number of image pixels.

When the number of image pixels is acquired, subsequently, the control unit 300 performs processing for analyzing the image data and extracting edges in the image (step S104). The edges in the image can be extracted by various methods. As a simplest method, the edges in the image can be extracted by causing a two-dimensional filter such as a Sobel filter to act on the image data.

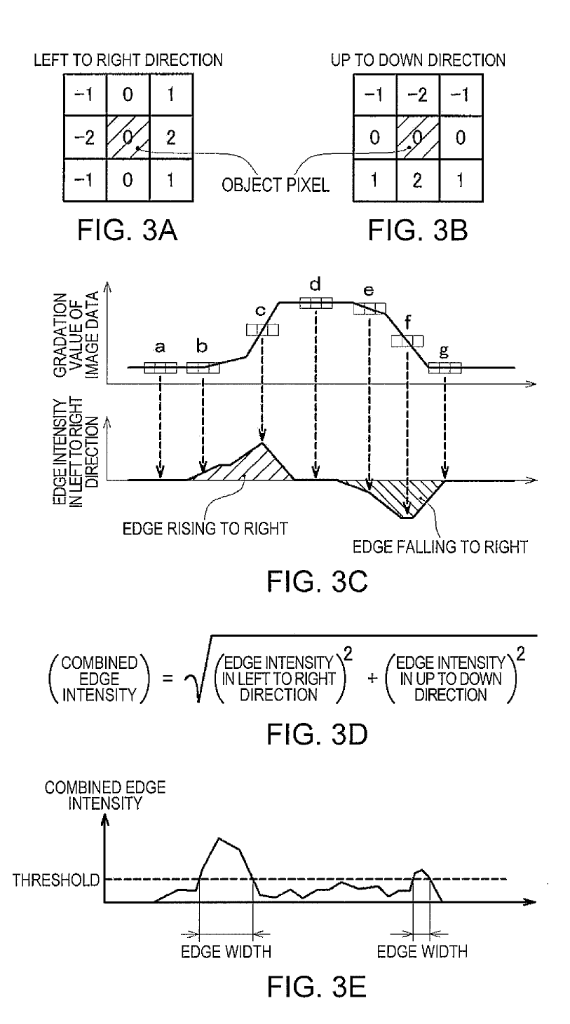

FIGS. 3A to 3E are diagrams for explaining a state in which edges in an image are detected by using Sobel filters. In FIG. 3A, a Sobel filter that detects edges in a left to right direction is shown as an example. In FIG. 3B, a Sobel filer that detects edges in an up to down direction is shown as an example. As shown in the figures, in the Sobel filters, predetermined weighting factors are set in peripheral pixels around an object pixel. When the Sobel filters are caused to act on image data, operation for multiplying image data of the pixels around the object pixel with the weighting factors and setting a value obtained by totaling the image data multiplied with the weighting factors as a value of the object pixel is performed. As an example, in FIG. 3C, a state in which the Sobel filter in the left to right direction is caused to act on the image data is shown. Rectangles indicated by thin lines in the figure schematically represent the Sobel filter. When the Sobel filter is in a position “a” (i.e., a position where a gradation value does not change), a value obtained by weighting pixels ahead of the center of the Sobel filter and a value obtained by weighting pixels behind the center of the Sobel filter offset each other. Therefore, an output value (i.e., edge intensity) of the Sobel filter is nearly “0”. On the other hand, as in a position “b”, when the front of the Sobel filter is over an edge, the edge intensity takes a positive value. As in a position “c”, when the entire Sobel filter is included in the edge, the edge intensity increases. As in a position “e”, in the case of the value on an edge falling to the right, the edge intensity takes a negative value. When the Sobel filter in the left to right direction is caused to act on the image data in this way, the edge intensity in the left to right direction can be detected. Similarly, when the Sobel filter in the up to down direction is caused to act on the image data, the edge intensity in the up to down direction can be detected. The edge intensities obtained in the left to right direction and the up to down direction, respectively, are combined by a formula shown in FIG. 3D. An example of edge intensity obtained by combining the edge intensities is shown in FIG. 3E. If the combined edge intensity and a predetermined threshold are compared and the number of pixels in which the edge intensity continuously exceeds the threshold is detected, edge width can be extracted. In step S102 shown in FIG. 2, processing for extracting edges included in the image is performed as described above.

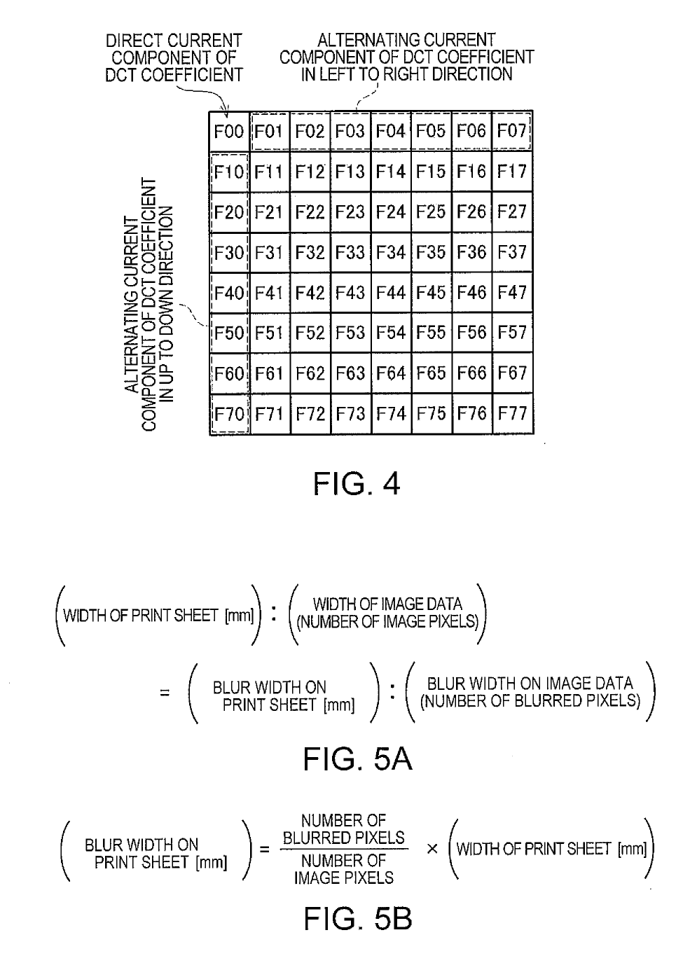

In extracting edges in the image, a method of extracting edges is not limited to the method of using the Sobel filters described above and other methods may be used. For example, when the image data is stored, the image data is converted into a JPEG format. Therefore, if this conversion of a format is utilized, edges can be relatively easily extracted as described below. FIG. 4 is a diagram for explaining image data for one block stored in the JPEG format. In the image data of the JPEG format, DCT coefficients are stored in respective pixels rather than gradation values of the image data. A DCT coefficient is a value corresponding to a magnitude of a frequency component included in an image for one block. Frequency components can also be assumed in a vertical direction and a horizontal direction, respectively, in association with the fact that the image is two-dimensional. The DCT coefficient is present for each combination of the respective frequency components in the vertical direction and the horizontal direction (i.e., two-dimensionally). JPEG is a format for, rather than representing image data according to a gradation value for each of pixels, dividing an image into blocks of a predetermined size (usually, eight pixels each vertically and horizontally) and representing images of the respective blocks according to magnitudes of two-dimensional frequency components (DCT coefficients). DCT coefficients of high-frequency components have only the small influence on the images and thereby an image quality is hardly deteriorated even if the DCT coefficients are omitted. Therefore, it is possible to compress a data size of the image by omitting the high-frequency components. As shown in FIG. 4, if the DCT coefficients in the left to right direction are used, a change in the left to right direction included in the image can be reproduced. If the DCT coefficients in the up to down direction are used, a change in the up to down direction can be reproduced. Therefore, if the image data is once converted into the JPEG format, it is possible to calculates edge widths in the left to right direction and the up to down direction and extract edge width obtained by combining the edge widths by reading out the DCT coefficients in the left to right direction and the up to down direction and analyzing the DCT coefficients.

When the edges in the image are extracted as described above (step S104 in FIG. 2), the control unit 300 performs processing for calculating, on the basis of the extracted edges, “the number of blurred pixels” representing blur width of the image data (step S106). When the image is blurred because of defocusing or hand shake, since a contour (edges) of an object are blurred, the width of the edges widens. Conversely, when the image is in focus, since the contour of the object is clear, the edge width narrows. Therefore, it can be considered that the edge width of the edges extracted from the image represents blur width of the image. Therefore, the control unit 300 calculates, on the basis of the edge width of the edges extracted in step S104, “the number of blurred pixels” representing blur width of the image. Various methods can be used to calculate the number of blurred pixels. As a simple method, an average of the edge width of the extracted edges only has to be calculated and set as the number of blurred pixels. Alternatively, it is also possible that a histogram of the edge width is created and a mode value of the histogram is used as the number of blurred pixels. Since the edge width is represented by the number of pixels, “the number of blurred pixels” is also an amount represented by the number of pixels.

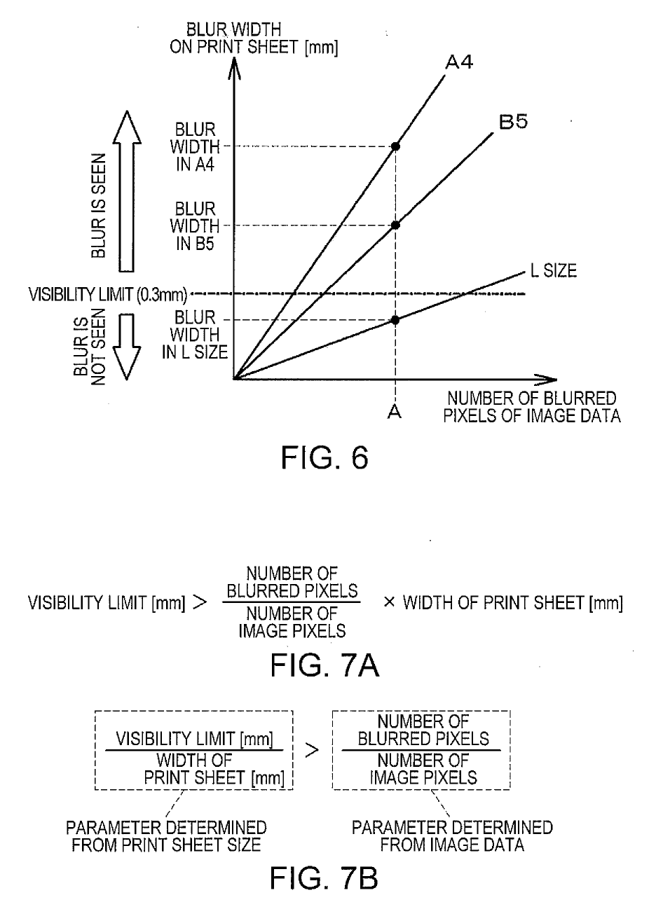

When the number of blurred pixels is calculated, the control unit 300 performs, on the basis of the number of blurred pixels and the number of image pixels acquired earlier (see step S102), processing for determining a maximum size in which the image can be printed while a quality of the image is maintained (an upper limit output size) (step S108). In this processing, the control unit 300 compares a parameter decided from the number of blurred pixels and the number of image pixels with a parameter set for each of sheet sizes to thereby determine an upper limit output size. However, to facilitate understanding, first, a principle of determining an upper limit output size from blur width at the time when the image is actually printed is explained with reference to FIGS. 5A and 5B and FIG. 6.

FIGS. 5A and 5B are diagrams for explaining a method of calculating blur width on a print sheet to which blur width (the number of blurred pixels) on image data changes when the image is actually printed. As shown in FIG. 5A, there is a simple proportional relation between the blur width on the image data and the blur width on the print sheet at the time when the image is actually printed. Therefore, if a formula of FIG. 5B derived from this relation is used, it is possible to learn the blur width on the print sheet to which the blur width on the image data changes when the image is actually printed. If the blur width on the print sheet is calculated, it is possible to judge as described below whether an image can be printed while a quality of the image is maintained.

FIG. 6 is diagram for explaining a state in which it is judged from the blur width on the print sheet whether it is possible to print the image data without deteriorating a quality. A graph shown in FIG. 6 represents a relation between the number of blurred pixels of the image data and the blur width on the print sheet calculated according to the formula of FIG. 5B. As shown in the graph, when the number of blur pixels of the image data (on the abscissa of the graph) increases, the blur width on the print sheet (on the ordinate of the graph) also increases. As a size of the print sheet increases from the L size to B5 and A4, the image is extended to be large. Therefore, the blur width also increases. Therefore, it is judged whether an image can be printed in the size according to whether this blur width is smaller than a limit that the human can visually recognize (a visibility limit). For example, in the case of image data in which the number of blurred pixels is indicated by A in the figure, as shown in the figure, blur width of the L size is smaller than the visibility limit (in an example shown in FIG. 6, 0.3 mm). Conversely, in the B5 size and the A4 size, blur width is larger than the visibility limit. In other words, when the image is printed in the L size, even if a blur is seen on the image data, the blur is not seen on the printed image. Therefore, a quality of the image is not deteriorated by printing the image. Conversely, when the image is printed in the B5 size or the A4 size, since a blur is seen, a quality of the printed image is deteriorated. In this way, if it is judged whether the blur width on the print sheet is larger than the visibility limit, it is possible to judge whether it is possible to print the image while maintaining a quality of the image.

In FIG. 6, 0.3 mm is used as a value of the visibility limit. However, strictly, the value of the visibility limit is not always 0.3 mm. For example, the value of 0.3 mm in FIG. 6 is a typical visibility limit for the user who holds a printed image at hand and enjoys the printed image. However, when an image is small, the visibility limit is higher because the user holds the image and enjoys the image in a position closer to the user. Conversely, when an image is large, the visibility limit is lower because the user enjoys the image in a position away from the user. In such a case, a smaller value or a larger value may be used.

FIGS. 7A and 7B are diagrams for explaining, using formulas, the method of judgment according to the principle explained above. As described above, it is possible to judge, according to whether the blur width on the print sheet is smaller than the visibility limit, whether it is possible to print the image while maintaining a quality of the image. This can be represented by an inequality shown in FIG. 7A. From a different point of view, the method of judgment according to. FIG. 7A can be grasped as shown in FIG. 7B. The left side of FIG. 7B is a parameter determined from a size of the print sheet. On the other hand, the right side is a parameter determined from the image data about to be printed. In other words, by comparing the parameter (on the left side) set for each of sheet sizes and the parameter (on the right side) extracted from the image data, it is possible to judge whether the image can be printed in the size.

As explained above, the judgment on whether it is possible to print the image without deteriorating a quality of the image eventually results in judgment on whether a formula shown in FIG. 7B is satisfied. Therefore, in step S108 in FIG. 2, the control unit 300 compares the parameter on the left side of FIG. 7B determined for each of sheet sizes and the parameter on the right side of FIG. 7B extracted from the image data to thereby judge whether the image can be outputted in the sheet size. The control unit 300 determines a maximum sheet size among sheet sizes in which the image can be outputted as a “limit output size”.

A value of the parameter on the left side can also be calculated from the visibility limit and the width of the print sheet. The value of the parameter may be decided in advance by a so-called sensory evaluation experiment. For example, plural images having different values of the parameter on the right side of FIG. 7B are printed in the same size and shown to a subject to cause the subject to classify the images into high-quality images and low-quality images. If the parameter values of the high-quality images and the parameter values of the low-quality images are compared, a boundary between the high-quality images and the low-quality images can be found. Therefore, the boundary can be set as the parameter value on the left side. If a parameter value for each of sheet sizes is set by such a sensory evaluation experiment, even if a value of the visibility limit is unknown, it is possible to determine an appropriate parameter value. As described above, when an image is small, the user may enjoy the image in a position closer to the user. Conversely, when an image is large, the user may enjoy the image in a position away from the user. However, if a parameter value is determined by such a sensory evaluation experiment, even when a value of the visibility limit is different depending on a size of an image, it is possible to set an appropriate parameter value.

As explained above, in step S108 in FIG. 2, the control unit 300 judges, using the formula shown in FIG. 7B, whether it is possible to print the image while maintaining qualities for various sheet sizes and determines a maximum size in which the image can be printed (an upper limit output size) when the upper limit output size is determined in this way, the control unit 300 finishes the “image data analysis processing” shown in FIG. 2.

In this way, in the image data analysis processing according to this embodiment, the upper limit output size is determined by comparing the parameters (the number of blurred pixels and the number of image pixels) extracted from the image data and the parameter of the sheet sizes. Therefore, it is possible to determine an appropriate output size corresponding to performance during photographing of an image. In other words, if the image is a focused preferable image, the upper limit output size is increased. Conversely, if the image is a blurred image, the upper limit output size is reduced to make the blur less conspicuous. Therefore, it is unlikely that defocusing and hand shake of a printed image become conspicuous and a quality is deteriorated. It goes without saying that the upper limit output size is determined by using not only the performance during photographing but also the number of pixels of the image data (the number of image pixels). Therefore, when an image is photographed by a digital camera with a large number of pixels, it is possible to determine a large size in association with the large number of pixels. Conversely, when an image is photographed by a digital camera with a relatively small number of pixels, it is possible to determine an appropriate size that does not make roughness of pixels conspicuous.

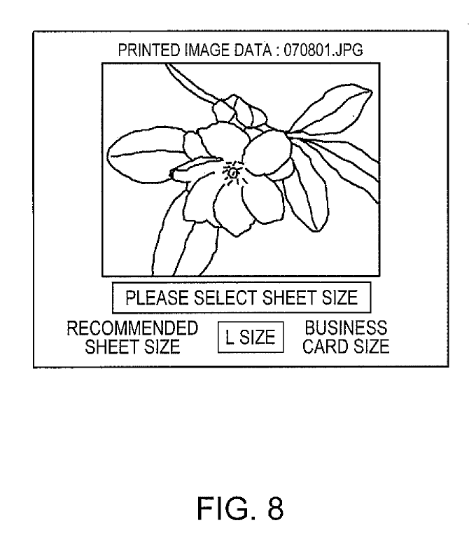

After the upper limit output size is determined in this way, it is possible to inform the user of a printable size by displaying the upper limit output size on the monitor screen. FIG. 8 is a diagram for explaining a state in which recommended sheet sizes are displayed on the monitor screen. As described above, when a sheet has the upper limit output size or a size smaller than that, it is possible to print the image while keeping a quality of the image. Therefore, these sizes are displayed on the monitor screen as the recommended sheet sizes. In this way, the user can obtain a preferable printed image by selecting a favorite size out of these sheet sizes. It goes without saying that, when a desired size is not recommended, the user can stop the printing. Further, the user can learn an appropriate print size even if the user does not actually print the image. Therefore, it is possible to easily obtain a preferable image without performing complicated work of checking an appropriate size while printing the image. In addition, the user selects a print size out of the recommended sizes displayed on the monitor screen. Therefore, the image is not printed by mistake in a size in which a quality is deteriorated. Therefore, it is possible to prevent a situation in which a low-quality image is printed to wastefully consume print sheets and inks for printing.

After the upper limit output size is determined, in addition to the display of the recommended sheet sizes on the monitor screen, the upper limit output size may be recorded in a header portion of the image data. Alternatively, the upper limit output size may be recorded in a management file for managing a storage area (a directory, etc.) in which the image data is recorded. Consequently, when the image data is printed again, it is possible to more quickly determine a print size by reading out the recorded upper limit output size. Even when the image is outputted in other printing apparatuses and the like not mounted with the image data analyzing device according to this embodiment, an appropriate output size is known if the recorded upper limit output size is read out. Therefore, it is possible to obtain a preferable image by outputting the image in the size.

Moreover, in the printing apparatus 10 according to this embodiment, by determining upper limit output sizes for plural images, it is also possible to select image data that can be printed in a designated size. “Image data selection processing” for realizing such processing is explained below.

### C. Image Data Selection Processing

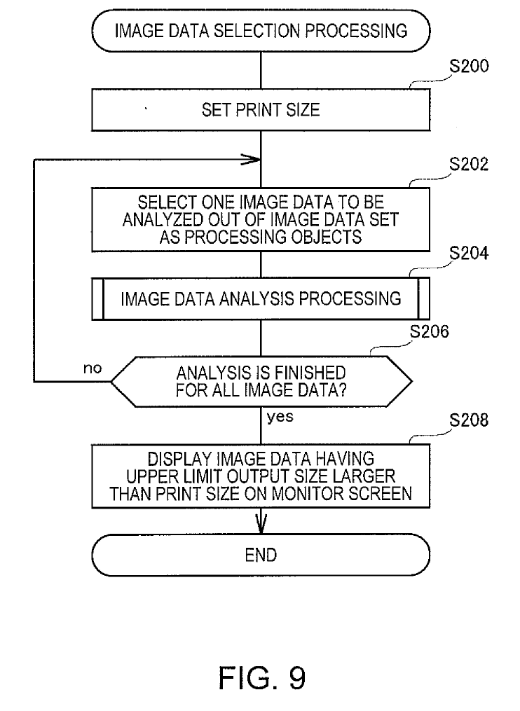

FIG. 9 is a diagram for explaining a flow of the “image data selection processing” according to this embodiment. Such processing is processing executed by the control unit 300 according to the operation of an operation panel by the user. When the processing is started, first, the control unit 300 performs processing for setting a print size (step S200). The control unit 300 displays various print sizes on the monitor screen. Therefore, looking at the print sizes, the user operates the operation panel to select a desired print size out of the displayed sizes. Rather than the user setting a print size, the control unit 300 may detect a size of a print sheet inserted in the printing apparatus 10 and set the size as a print size.

when the print size is set, subsequently, the control unit 300 performs processing for selecting one image data to be analyzed out of plural image data set as processing objects (step S202). The image data set as the processing objects may be image data recorded in a computer connected to the printing apparatus 10 or may be image data recorded in a recording medium inserted in the printing apparatus 10. All image data recorded in the computer or the recording medium may be set as processing objects or only image data recorded in a predetermined directory may be set as processing objects. Actually, the user does not need to perform operation for selecting image data. The control unit 300 selects image data in order according to a list of image data set as processing objects.

When one image data to be analyzed is selected, the control unit 300 executes the “image data analysis processing” on this image data and acquires an upper limit output size of the image data (step S204). When the upper limit output size is obtained for the one image data, the control unit 300 judges whether the analysis is finished for all the image data (step S206). When the analysis is not finished for all the image data (step S206: no), the control unit 300 returns to step S202, selects image data to be analyzed, and executes the image data analysis processing. When the analysis is finished for all the image data (step S206: yes), the control unit 300 selects image data having an acquired upper limit output size larger than the print size set earlier (i.e., image data that can be printed in the set print size), displays an image of the image data on the monitor screen (step S208), and finishes the image data selection processing.

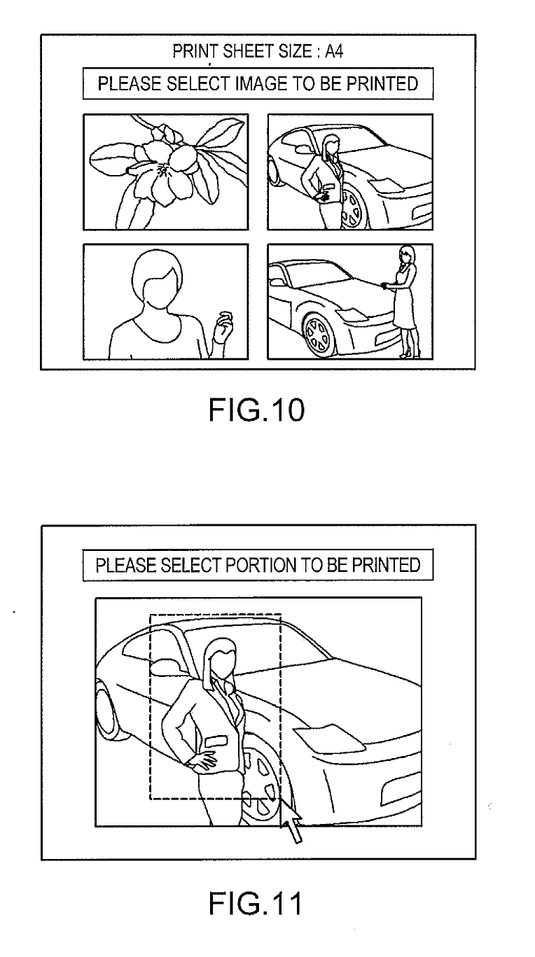

FIG. 10 is a diagram for explaining an example of a state in which selected images are displayed on the monitor screen. As shown in the figure, in this example, the A4 size is set as a print size and four image data that can be printed in the A4 size are displayed on the monitor screen. If image data to be printed is selected out of the image data displayed on the monitor screen in this way, a quality of a printed image is not deteriorated because an upper limit output size of these image data is larger than the set print size. The user can obtain a preferable printed image. In this case, only image data that can be printed with an appropriate quality is displayed on the monitor screen. Therefore, even when a large number of image data are recorded in a recording medium, the user can easily select image data suitable for printing. For example, when the user photographs an image with a digital camera, the user may photograph the same object many times for fear of failing in the photographing. In such a case, since many similar image data are recorded in the recording medium, in printing the image data, the user may not be able to decide which image data should be printed. Even in such a case, since only the printable image data are displayed on the monitor screen, the user can easily select image data to be printed. As a result, it is possible to easily obtain a preferable printed image.

After acquiring upper limit output sizes of the respective image data according to the image data selection processing, the image data may be classified on the basis of the upper limit output sizes of the respective image data. In other words, a storage area such as a directory is created for each of the various sheet sizes. Image data having upper limit output sizes larger than the sheet size (i.e., image data that can be printed in the sheet size) are stored in each of the directories. Consequently, in printing an image again, image data only has to be selected out of a directory of a sheet size in which the image is desired to be printed. Therefore, the user can more easily obtain a printed image of a preferable quality.

### D. Modifications

### D-1. First Modification

In the explanation of the embodiment described above, it is assumed that an upper limit output size in printing an entire image is determined (see step S108 in FIG. 2). However, an upper limit output size in printing a part of an image rather than an entire image may be determined.

FIG. 11 is a diagram for explaining a state in which a user selects a part of an image. As shown in the figure, an image and a cursor are displayed on the monitor screen of the control unit 300. Therefore, the user can select, by operating the cursor while looking at the monitor screen, a portion desired to be printed. When the user selects the portion desired to be printed, the control unit 300 extracts data of the portion selected by the user and acquires the number of blurred pixels and the number of image pixels from the extracted data. To acquire the number of blurred pixels, the control unit 300 only has to apply the edge extraction processing to the extracted data in the same manner as the embodiment described above (see step S104 in FIG. 2). To acquire the number of image pixels, the control unit 300 only has to analyze the extracted data and check a total number of pixels, a number of vertical pixels, a number of horizontal pixels, and the like of the portion selected by the user. When the number of blurred pixels and the number of image pixels are acquired in this way, the control unit 300 applies the formula shown in FIG. 7B and determines an upper limit output size on the basis of the acquired number of blurred pixels and the acquired number of image pixels.

Consequently, since the upper limit output size is determined from the number of blurred pixels and the number of image pixels of the portion selected by the user, it is possible to obtain an upper limit output size in printing only the selected portion. In this case, the upper limit output size is determined from only the portion selected by the user and other portions are not used. Therefore, it is possible to determine the upper limit output size without being affected by the image except the selected portion. In other words, if the portion desired to be printed is in focus, it is judged that the portion can be printed in a large size even if the other portions are out of focus. Conversely, if the portion desired to be printed is blurred, it is judged that portion can be printed only in a small size even if the other portions are in focus. In this way, since the upper limit output size is determined only from the selected portion, it is possible to learn an appropriate print size only for the selected portion regardless of a state of blurs in the other portions. If the selected portion is printed in the size, the user can obtain a printed image of a preferable quality.

### D-2. Second Modification

In the explanation of the embodiment described above, since a visibility limit slightly fluctuates depending on a size of a print sheet, it is assumed that a value of the visibility limit is changed for each of sizes of print sheets to determine an upper limit output size (see FIG. 7B). However, the upper limit output size may be determined by changing value of the visibility limit according to not only a size of a print sheet but also a distance for enjoying an image.

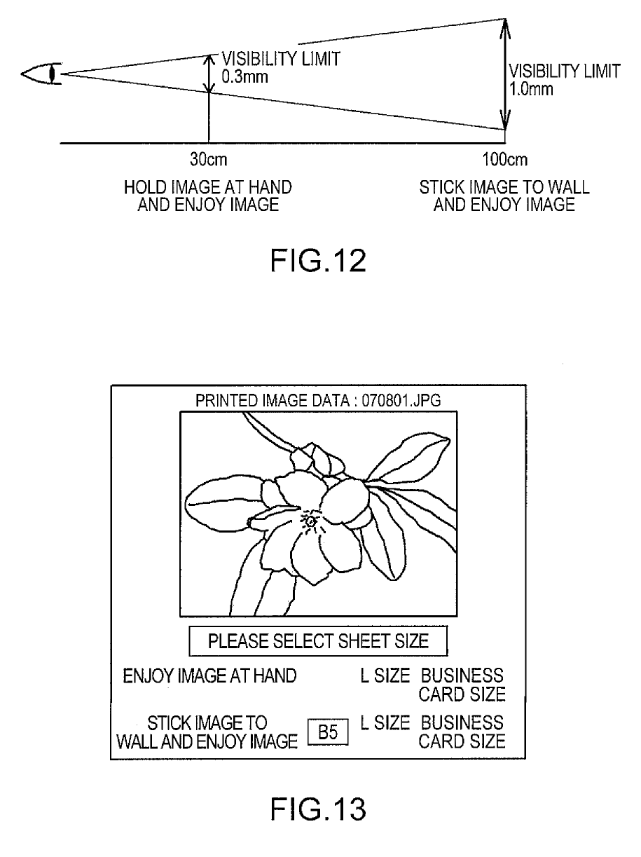

FIG. 12 is a diagram for conceptually explaining a state in which a visibility limit changes depending on a distance for enjoying an image. As shown in the figure, when the distance for enjoying an image increases, the visibility limit increases in proportion to the increase in the distance. For example, when a user sticks the image to a wall or the like and enjoys the image, the visibility limit is larger compared with that in enjoying the image at hand because the distance for enjoying the image is larger. From a different point of view, this can be grasped as described below. Even when a blur is conspicuous in a printed image and a quality of the printed image is deteriorated when the image is enjoyed by the user at hand, if the user sticks the image to the wall or the like and enjoys the image, a sufficient quality is obtained because no blur is seen. Therefore, in a second modification, a value of a visibility limit is changed depending on a distance for enjoying an image and an upper limit output size is calculated for each of distances for enjoying an image and displayed on a monitor screen.

FIG. 13 is a diagram for explaining an example of a state in which recommended print sizes for enjoying an image at hand and on a wall are displayed on the monitor screen. As shown in the figure, when the user holds the image at hand and enjoys the image, an L size and a business card size are recommended. On the other hand, when the user sticks the image to the wall and enjoys the image, since the visibility limit increases as the image is set farther apart from the user, a larger B5 size is also recommended in addition to the L size and the business card size. If the user enjoys the image at hand, the user only has to select the L size or the business card size and print the image. If the user sticks the image to the wall and enjoys the image, since a sufficient quality is obtained in the larger B5 size as well, the user can also print the image in the B5 size. In this way, when a recommended size is displayed for each of the enjoying methods, the user can select a print size according to the method of enjoying the image. Therefore, it is possible to print an image of a quality suitable for the enjoying method.

The image data analyzing device according to this embodiment has been explained. However, the invention is not limited to the embodiment. It is possible to carry out the invention in various forms without departing from the spirit of the invention.

For example, in this embodiment, the image data analyzing device is mounted on the printing apparatus. However, the image data analyzing device is not limited to be mounted on the printing apparatus. For example, it is also possible to mount the image data analyzing device on image display apparatuses such as a liquid crystal display and a CRT display and image photographing apparatuses such as a digital camera and a cellular phone with camera. Moreover, it is also possible to mount the image data analyzing device on unattended photography printing terminals set in towns and cities and in public places.

The entire disclosure of Japanese Patent Application No. 2007-228605, filed Sep. 4, 2007 is expressly incorporated by reference herein.

What is claimed is:

1. An image data analyzing device that analyzes image data, the image data analyzing device comprising:
a number-of-blurred-pixels detecting unit that detects a number of blurred pixels, which is a number of pixels indicating blur width of a contour in an image represented by the image data;
a number-of-image-pixels acquiring unit that acquires a number of image pixels, which is a number of pixels related to a size of the image represented by the image data; and
an upper-limit-output-size determining unit that determines, on a basis of the number of blurred pixels and the number of image pixels of the image data, an allowable upper limit output size of an image outputted by using the image data.

2. The image data analyzing device according to claim 1, further comprising:
an image-data storing unit having stored therein image data;
an image-size setting unit that sets an image size, which is a size of an image about to be outputted;
an image-data supplying unit that supplies the image data stored in the image-data storing unit to the number-of-blurred-pixels detecting unit; and
an image-data selecting unit that selects image data, the upper limit output size determined by the upper-limit-output-size determining unit of which is larger than the image size set by the image-size setting unit, out of the image data stored in the image-data storing unit.

3. The image data analyzing device according to claim 1, wherein
the upper-limit-output-size determining unit includes a blur-width calculating unit that calculates, on the basis of the number of blurred pixels and the number of image pixels, blur width in the image at a time when the image is outputted in an assumed size, and
the upper-limit-output-size determining unit is a unit that determines the upper limit output size by comparing the blur width calculated by the blur-width calculating unit and predetermined blur allowable width.

4. An image data analyzing method of image data, the image data analyzing method comprising:
detecting a number of blurred pixels, which is a number of pixels indicating blur width of a contour in an image represented by the image data;
acquiring a number of image pixels, which is a number of pixels related to a size of the image represented by the image data; and
determining, on a basis of the number of blurred pixels and the number of image pixels of the image data, an allowable upper limit output size of an image outputted by using the image data.

5. A computer-readable storage medium including a program stored thereon, the program comprising:
a first program code that makes an computer detect a number of blurred pixels, which is a number of pixels indicating blur width of a contour in an image represented by the image data;
a second program code that makes the computer acquire a number of image pixels, which is a number of pixels related to a size of the image represented by the image data; and
a third program code that makes the computer determine, on a basis of the number of blurred pixels and the number of image pixels of the image data, an allowable upper limit output size of an image outputted by using the image data.
